(19) United States
(12) Patent Application Publication
(10) Pub. No.: US 2026/0043226 A1
(43) Pub. Date: Feb. 12, 2026

(54) PORTABLE, TOWABLE SHADE APPARATUS AND METHODS

(71) Applicant: William H. BIGELOW, Houston, TX (US)

(72) Inventor: William H. BIGELOW, Houston, TX (US)

(21) Appl. No.: 18/994,475

(22) PCT Filed: Jul. 6, 2023
(86) PCT No.: PCT/US2023/027037

§ 371 Date: Jan. 14, 2025

Related U.S. Application Data
(60) Provisional application No. 63/389,806, filed on Jul. 15, 2022.

(51) Int. Cl. E04B 1/344; B62D 63/08; E04B 1/343

(52) U.S. Cl. CPC E04B 1/3444; B62D 63/08; E04B 1/34336

(57) ABSTRACT

A portable, towable shade system includes a front bulkhead, a rear bulkhead, a fixed roof structure, and one or more roof panel assemblies. The fixed roof structure is coupled between the top of the front bulkhead and the top of the rear bulkhead such that the area under the fixed roof structure between the front and rear bulkheads is open to the ground. The shade system also includes one or more roof panel assemblies pivotably coupled to one or more of the front bulkhead, rear bulkhead, or fixed roof structure. The roof panel assemblies are pivotably deployable to provide shade over the area therebelow. The roof panel assemblies may also have telescoping extensions that can further extend coverage.

### CROSS-REFERENCE TO RELATED APPLICATIONS

This application claims priority from U.S. provisional application number 63/389,806, filed Jul. 15, 2022, which is incorporated by reference herein in its entirety.

### TECHNICAL FIELD/FIELD OF THE DISCLOSURE

The present disclosure relates to vehicles for providing portable shade areas.

### BACKGROUND OF THE DISCLOSURE

In sunny conditions, radiant heat from the sun can cause temperatures to feel significantly warmer than the ambient air temperature. Exposure to the sun can cause injury to people or animals and can lead to conditions such as heat exhaustion or heat stroke. The ability to find or provide shade on a hot, sunny day can reduce or prevent such occurrences.

### SUMMARY

The present disclosure provides for a portable shade system. The portable shade system may include a front bulkhead. The portable shade system may include a rear bulkhead. The portable shade system may include a fixed roof structure, the fixed roof structure coupled between the top of the front bulkhead and the top of the rear bulkhead. The portable shade system may include a roof panel assembly, the roof panel assembly pivotably coupled to one or more of the front bulkhead, rear bulkhead, or fixed roof structure.

The present disclosure also provides for a method. The method may include providing a portable shade system. The portable shade system may include a front bulkhead. The portable shade system may include a hitch coupled to the front bulkhead. The portable shade system may include a rear bulkhead. The portable shade system may include wheels coupled to the rear bulkhead. The portable shade system may include a fixed roof structure, the fixed roof structure coupled between the top of the front bulkhead and the top of the rear bulkhead. The portable shade system may include a roof panel assembly, the roof panel assembly pivotably coupled to one or more of the front bulkhead, rear bulkhead, or fixed roof structure. The method may include coupling the portable shade system to a tow vehicle by the hitch, transporting the portable shade system to a desired location using the tow vehicle, and pivoting the roof panel assembly from a closed position to an open position

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 depicts a perspective view of a portable shade system consistent with at least one embodiment of the present disclosure.

FIG. 2 depicts a partially-transparent perspective view of the portable shade system of FIG. 1 in a deployed position.

FIG. 2A depicts a partially-transparent view of a portable shade system consistent with at least one embodiment of the present disclosure.

FIG. 3 depicts a perspective view of the portable shade system of FIG. 1 in an extended position.

### DETAILED DESCRIPTION

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

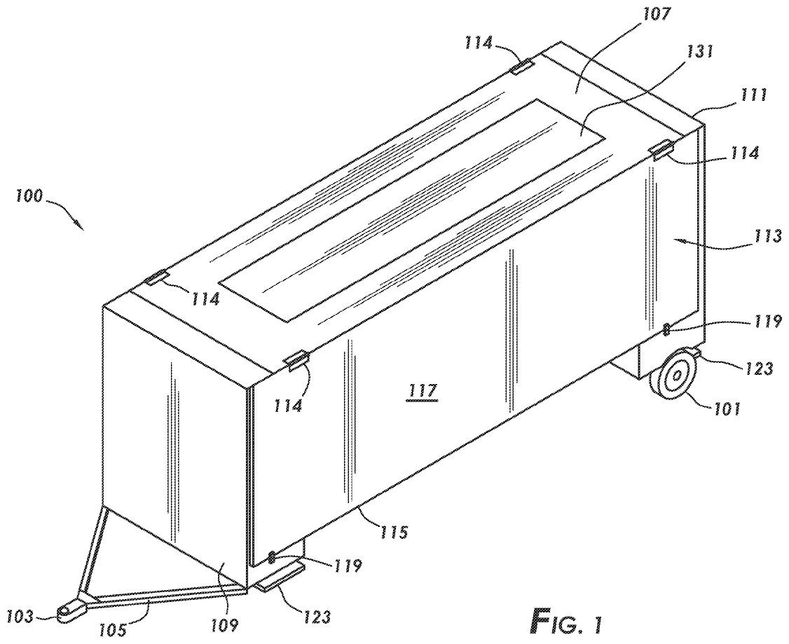

FIGS. 1-3 depict portable shade system 100 consistent with at least one embodiment of the present disclosure. In some embodiments, portable shade system 100 may form at least part of a trailer. Portable shade system 100 may include wheels 101 to allow transportation of portable shade system 100. In some embodiments, portable shade system 100 may include hitch 103 to allow portable shade system 100 to be coupled to a vehicle for transportation. In some embodiments, hitch 103 may be positioned on gooseneck 105. In certain embodiments, the trailer may be used to carry modular structures, pre-fabricated structures, or other items that can be raised or lowered to grade level or foundation using a mechanical or hydraulic system.

In some embodiments, portable shade system 100 may include fixed roof structure 107, which may, for example and without limitation, couple between hitch 103 and wheels 101. In some such embodiments, fixed roof structure 107 may couple between front bulkhead 109 and rear bulkhead 111, wherein hitch 103 is coupled to front bulkhead 109 and wheels 101 are coupled to rear bulkhead 111. In some embodiments, one or both of front bulkhead 109 and rear bulkhead 111 may include storage space. Front bulkhead 109 and rear bulkhead 111 may support fixed roof structure 107 at a position above the ground such that front bulkhead 109, rear bulkhead 111, and fixed roof structure 107 form a trabeated structure, with fixed roof structure 107 spanning between front bulkhead 109 and rear bulkhead 111, leaving open the ground below fixed roof structure 107. In some embodiments, fixed roof structure 107 may include a structural component such as a truss. In some embodiments, fixed roof structure 107 may be covered with or formed from one or more materials such as, for example and without limitation, solid materials, structural materials, composite materials, netting, perforated materials including perforated metal and perforated vinyl, etc.

In some embodiments, portable shade system 100 may include roof panel assemblies 113. Roof panel assemblies 113 may be pivotably coupled to one or more of fixed roof structure 107, front bulkhead 109, and rear bulkhead 111 by hinges 114. In some embodiments, a roof panel assembly 113 may be positioned on each side of fixed roof structure 107.

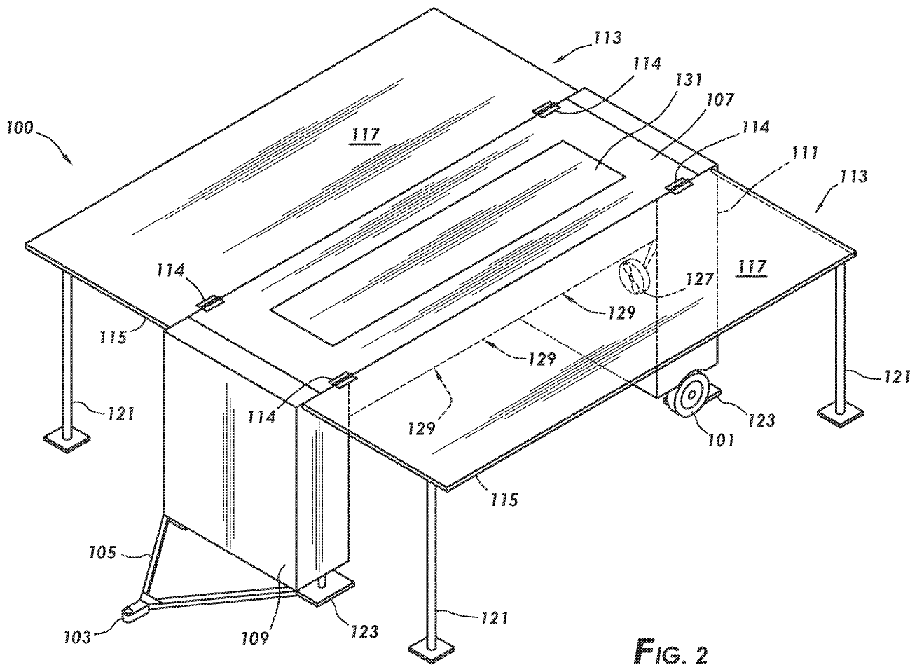

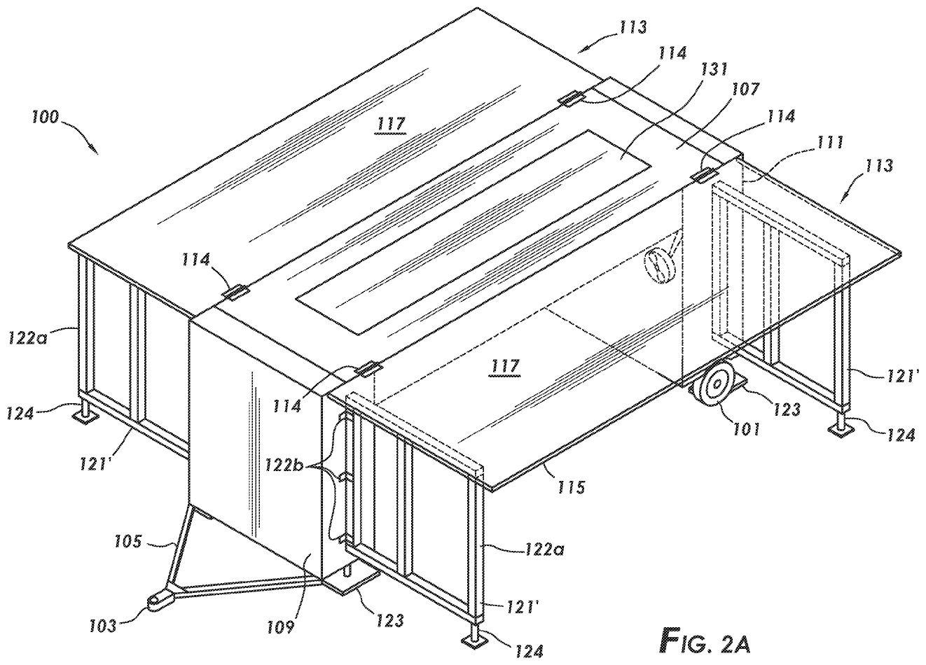

Roof panel assemblies 113 may be pivotable between a closed position as shown in FIG. 1 and an open position as shown in FIG. 2. Roof panel assemblies 113 may include roof frames 115 and roof panels 117. Roof frames 115 may be rigid and may, when in the closed position depicted in FIG. 1, latch to front bulkhead 109 and rear bulkhead 111 using one or more couplers 119. In some embodiments, the length of roof panel assemblies 113 may be increased or decreased to increase or decrease the amount of shade from portable shade system 100, while maintaining the distance between front bulkhead 109 and rear bulkhead 111. Couplers 119 may include, for example and without limitation, a pin or bolt connection such as a slide bolt. Roof panel assemblies 113 may, when in the closed position, form sidewalls of portable shade system 100. Without being bound to theory, latching roof panel assemblies 113 may provide structural rigidity to portable shade system 100 while portable shade system 100 is in transportation despite the floorless design of portable shade system 100. Roof panel assemblies 113 may provide longitudinal, torsional, and bending rigidity between front bulkhead 109 and rear bulkhead 111, allowing portable shade system 100 to be transported.

In some embodiments, roof panels 117 may be solid, such as formed from sheet metal secured to roof frames 115. In other embodiments, roof panels 117 may be formed from netting or a perforated material secured to roof frames 115. In some embodiments, roof panels 117 may be formed from one or more materials such as, for example and without limitation, solid materials, structural materials, composite materials, netting, perforated materials including perforated metal and perforated vinyl, etc.

When roof panel assemblies 113 are in the open position, as shown in FIG. 2, roof panels 117 may provide cover to the area therebeneath. This cover may be used, for example and without limitation, by people or animals seeking protection from the sun or other meteorological conditions.

In some embodiments, when in the open position, roof panel assemblies 113 may be supported by one or more supports 121. Supports 121 may, in some embodiments, be foldingly coupled to roof panel assemblies 113 and may extend between roof panel assemblies 113 and the ground. In some embodiments, one or both of front bulkhead 109 and rear bulkhead 111 may include one or more jack stands 123 positioned to, once portable shade system 100 is transported to a desired location, extend to the ground and provide support for portable shade system 100 and resistance to movement thereof.

In some embodiments, as shown in FIG. 2, supports 121 may be vertical stanchions that extend between the ground and roof panel assemblies 113. In other embodiments, as shown in FIG. 2A, supports 121′ may include frame 122a, which may be hingedly coupled to roof panel assembly 113, front bulkhead 109, or rear bulkhead 111 by hinges 122b. Frame 122a may, in some embodiments, be formed from multiple bars to form a rigid gate-like assembly. In some embodiments, supports 121 or 121′ may include support jack stand 124 positioned at a lower end of support 121, 121′ such that engagement of supports 121, 121′ with the ground can be assured and to provide support to portable shade system 100.

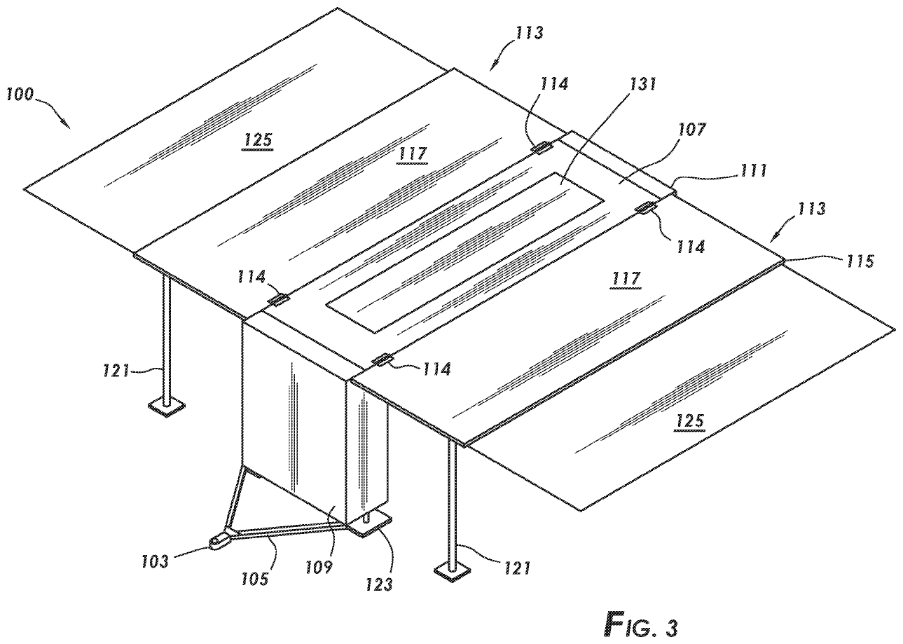

In some embodiments, roof panel assemblies 113 may include telescoping extensions 125, as shown in FIG. 3. Telescoping extensions 125 may be slidingly coupled to roof frames 115 such that telescoping extensions 125 may traverse laterally outward to provide additional coverage area of portable shade system 100. Telescoping extensions 125 may be formed from a solid material such as sheet metal or may be formed from netting on frame. In some embodiments, telescoping extensions 125 may be formed from one or more materials such as, for example and without limitation, solid materials, structural materials, composite materials, netting, perforated materials including perforated metal and perforated vinyl, etc. Telescoping extensions 125 may be stored within roof panel assemblies 113 when roof panel assemblies 113 are in the closed position as discussed above.

In some embodiments, portable shade system 100 may include one or more fans 127 coupled to one or more of front bulkhead 109, rear bulkhead 111, fixed roof structure 107, or roof panel assemblies 113. Fans 127 may be positioned, for example and without limitation, to provide airflow to the area beneath fixed roof structure 107 and roof panel assemblies 113. In some embodiments, portable shade system 100 may include misting system 129 which may include one or more nozzles. Misting system 129 may spray water mist into the area beneath fixed roof structure 107 and roof panel assemblies 113 to, for example and without limitation, provide evaporative cooling. In some embodiments, portable shade system 100 may include one or more solar panels 131 positioned on fixed roof structure 107 or roof panel assemblies 113 to provide power to fans 127 and misting system 129.

In some embodiments, exterior surfaces of portable shade system 100 may be formed from a material that reflects radiative heat from the sun or may be coated with such a material.

In some embodiments, the outward dimensions of portable shade system 100 may be sized such that portable shade system 100 is road-haulable in the closed position. In some such embodiments, the overall length, width, and height of portable shade system 100 may be up to the limits imposed by local regulations. For example, in some embodiments, portable shade system 100 may be up to 50 feet long, 8′6″ wide, and 14′ tall when in the closed position. In other embodiments, such as where portable shade system 100 is used on private property, portable shade system 100 may be larger.

In operation, portable shade system 100 may be coupled to a tow vehicle by hitch 103. Portable shade system 100 may then be transported to a location at which shade is desired. Roof panel assemblies 113 may provide structural rigidity during this transportation operation. Portable shade system 100 may then be deployed. Jack stands 123 may be extended into contact with the ground to provide support and stability to portable shade system 100. Roof panel assemblies 113 may be unlatched from front bulkhead 109 and rear bulkhead 111 and pivoted to the open position as shown in FIG. 2. Supports 121 may be extended to support roof panel assemblies 113 in the open position. Telescoping extensions 125 may then be extended as shown in FIG. 3. In the fully deployed state, portable shade system 100 may thus provide shelter for, for example and without limitation, one or more of people; animals; vehicles including cars, buses, ambulances, and small planes; or any other desired use. Redeployment may be achieved by reversing the above operations.

The foregoing outlines features of several embodiments so that a person of ordinary skill in the art may better understand the aspects of the present disclosure. Such features may be replaced by any one of numerous equivalent alternatives, only some of which are disclosed herein. One of ordinary skill in the art should appreciate that they may readily use the present disclosure as a basis for designing or modifying other processes and structures for carrying out the same purposes and/or achieving the same advantages of the embodiments introduced herein. One of ordinary skill in the art should also realize that such equivalent constructions do not depart from the spirit and scope of the present disclosure and that they may make various changes, substitutions, and alterations herein without departing from the spirit and scope of the present disclosure.

1. A portable shade system comprising:
a front bulkhead;
a rear bulkhead;
a fixed roof structure, the fixed roof structure coupled between the top of the front bulkhead and the top of the rear bulkhead to define a floorless open area beneath the fixed roof structure between the front and rear bulk head; and
a roof panel assembly, the roof panel assembly pivotably coupled to one or more of the front bulkhead, rear bulkhead, or fixed roof structure.

2. The portable shade system of claim 1, further comprising a hitch coupled to the front bulkhead and wheels coupled to the rear bulkhead.

3. The portable shade system of claim 1, wherein the roof panel assembly is pivotable between a closed position and an open position.

4. The portable shade system of claim 3, further comprising one or more couplers positioned to couple the roof panel assembly to the front bulkhead or the rear bulkhead when in the closed position, such that the roof panel assembly provides structural rigidity to the portable shade system with the floorless open area between the front and rear bulkhead maintained in the closed position.

5. The portable shade system of claim 3, wherein the area beneath the roof panel assembly is open to the ground.

6. The portable shade system of claim 3, further comprising one or more supports extending between the roof panel assembly and the ground when the roof panel assembly is in the open position.

7. The portable shade system of claim 6, wherein the supports comprise one or more stanchions or one or more frames hingedly coupled to the front or rear bulkhead or the roof panel assembly.

8. The portable shade system of claim 7, further comprising a jack stand positioned at a lower end of the support and extending between the support and the ground.

9. The portable shade system of claim 3, further comprising one or more telescoping extensions, each telescoping extension slidingly coupled to a roof panel assembly such that the telescoping extension may extend laterally outward from the roof panel assembly when the roof panel assembly is in the open position to provide additional shade coverage area.

10. The portable shade system of claim 1, wherein the roof panel assembly comprises a roof panel, wherein the roof panel is formed from one or more of solid materials, structural materials, composite materials, netting, or perforated materials including perforated metal and perforated vinyl.

11. The portable shade system of claim 1, further comprising a fan coupled to the front bulkhead, rear bulkhead, fixed roof structure, or roof panel assembly.

12. The portable shade system of claim 1, further comprising a misting system.

13. The portable shade system of claim 1, further comprising a jack stand coupled to the front or rear bulkhead, the jack stand positioned to extend into contact with the ground to provide support to the portable shade system.

14. A method comprising:
providing a portable shade system, the portable shade system including:
a front bulkhead;
a hitch coupled to the front bulkhead;
a rear bulkhead;
wheels coupled to the rear bulkhead;
a fixed roof structure, the fixed roof structure coupled between the top of the front bulkhead and the top of the rear bulkhead to define a floorless open area beneath the fixed roof structure between the front and rear bulkhead; and
a roof panel assembly, the roof panel assembly pivotably coupled to one or more of the front bulkhead, rear bulkhead, or fixed roof structure;
coupling the portable shade system to a tow vehicle by the hitch;
transporting the portable shade system to a desired location using the tow vehicle; and
pivoting the roof panel assembly from a closed position to an open position.

15. The method of claim 14, further comprising extending a jack stand between the front bulkhead or rear bulkhead and the ground.

16. The method of claim 14, further comprising extending a support between the roof panel assembly and the ground.

17. The method of claim 14, further comprising extending a telescoping extension laterally outward from the roof panel assembly to provide additional shade coverage area.
